(19) United States
(12) Patent Application Publication
(10) Pub. No.: US 2005/0204371 A1
(43) Pub. Date: Sep. 15, 2005

(54) Disc depositing apparatus

(75) Inventors: Cheng-Fu Lee, Taipei (TW); Hsin-Jung Chuang, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/062,842

(22) Filed: Feb. 23, 2005

(30) Foreign Application Priority Data
Mar. 11, 2004 (TW) 93203728

(51) Int. Cl. G11B 17/03

(52) U.S. Cl. 720/601

(57) ABSTRACT

A disc depositing apparatus includes a main body and a base. The main body has a first side and a second side, which is opposite to the first side. A supporting member is disposed at the first side, and a protruding member is disposed on the surface of the base. The main body is coupled to the protruding member of the base via the supporting member so as to form a receiving space between the second side of the main body and the base.

This application claims the benefit of Taiwan application Serial No. 93203728, filed Mar. 11, 2004, the subject matter of which is incorporated herein by reference.

### BACKGROUND OF THE INVENTION

1. Field of the Invention

The invention relates in general to a depositing apparatus, and more particularly to a disc depositing apparatus.

2. Description of the Related Art

Various compact disc (CD) depositing apparatuses are provided in the market, and digital versatile disc player (DVD Player) is considered as the most shining future star in the multifunctional video players. A DVD player has all functions of video compact disc player (VCD player) and laser disc player (LD player), and it further has a function of recording to become a multifunctional DVD-R/RW player.

Referring to FIG. 1, it is a cross-section view of a conventional multi-functional disc player. A conventional digital versatile disc player (DVD player) 100 includes a base 102, a main body 104, a circuit board 106 and a cover 108.

The main body 104 is used for receiving, reading, and withdrawing a disc, and the main body 104 includes a tray, a disc driving motor, a spindle motor and an optical pickup head, all of which are disposed on the main body 104.

In the conventional DVD player 100, a MPEG decompressing chip needs to be applied on the circuit board so that the DVD player 100 can decompress all images. Therefore, a relatively larger space needs to be provided to dispose the MPEG decompressing chip and other corresponding circuits so that the circuit board of the DVD player 100 is larger and have to be separated from the main body 104. As shown in FIG. 1, the main body 104 and the circuit board 106 with a main body control chip 110 and a MPEG decompressing chip 112 are disposed on the base 102 separately.

Referring all to FIG. 1, FIG. 2A, FIG. 2B, and FIG. 3, FIG. 2A is a perspective view showing a main body of a conventional multi-functional disc player, FIG. 2B is a top view showing the main body in FIG. 2A, and FIG. 3 is a top view showing another main body.

In order to support the main body 104, and let the main body 104 be coupled to the base 102, supporting members 114 are disposed on both sides of the front part and both sides of the back part of the main body 104, as shown in FIG. 2A, and FIG. 2B. Or, the supporting members 114 are disposed on both sides of the front part and the back part of the main body 104, as shown in FIG. 3.

Conventionally, the main body 104 is locked onto the base 102 via a screw through the screw hole 116 of the supporting member 114 so as to have the main body 104 disposed on the base 102.

In order to prevent the screw from protruding outside of the base 102, a protruding member 118 is disposed on the surface of the base 102. So that the main body 104 is coupled to the protruding member 118 of the base 102 via the supporting member 114.

Referring both to FIG. 1, and FIG. 4, FIG. 4 is a top view of the conventional multi-functional disc player in FIG. 1. It is noticed that in FIG. 4, when the cover 108 of FIG. 1 is removed, the base 102, the main body 104, and the circuit board 106 can be seen directly without shelter of the cover 108.

Although the main body 104 and the circuit board 106 are disposed on the base 102, it is seen that most space within the base 102 is occupied by the main body 104 and the circuit board 106, as shown in FIG. 4. This configuration is unchangeable and lack of flexibility so that the space within the base 102 is limited.

### SUMMARY OF THE INVENTION

In view of the foregoing, it is an object of the present invention to provide a disc depositing apparatus so that the main body and the circuit board can be well-disposed on the base and makes the configuration more flexible.

The invention achieves the above-identified object by providing a disc depositing apparatus including a main body and a base. The main body has a first side and a second side, which is opposite to the first side. A supporting member is disposed at the first side, and a protruding member is disposed on the surface of the base. The main body is coupled to the protruding member of the base via the supporting member so as to form a receiving space between the second side of the main body and the base.

The abovementioned disc depositing apparatus further includes electronic means, part of which is disposed in the receiving space, and the electronic means preferably includes a circuit board. Further, a main body control chip and a MPEG decompressing chip are on the circuit board. Moreover, the abovementioned disc depositing apparatus includes a cover for covering the base and being connected thereto, and the disc depositing apparatus is preferably a digital versatile disc player (DVD player).

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a cross-section view of a conventional multi-functional disc player.

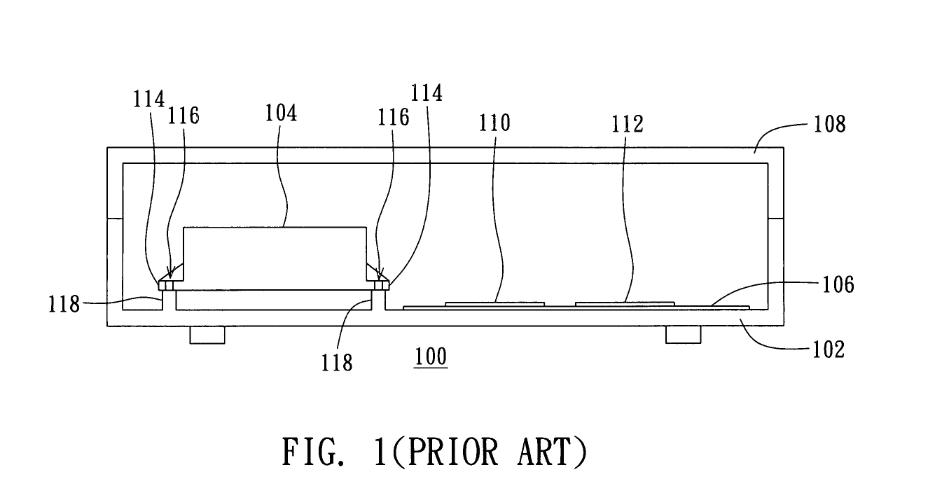

FIG. 2A (Prior Art) is a perspective view showing a main body of a conventional multi-functional disc player.

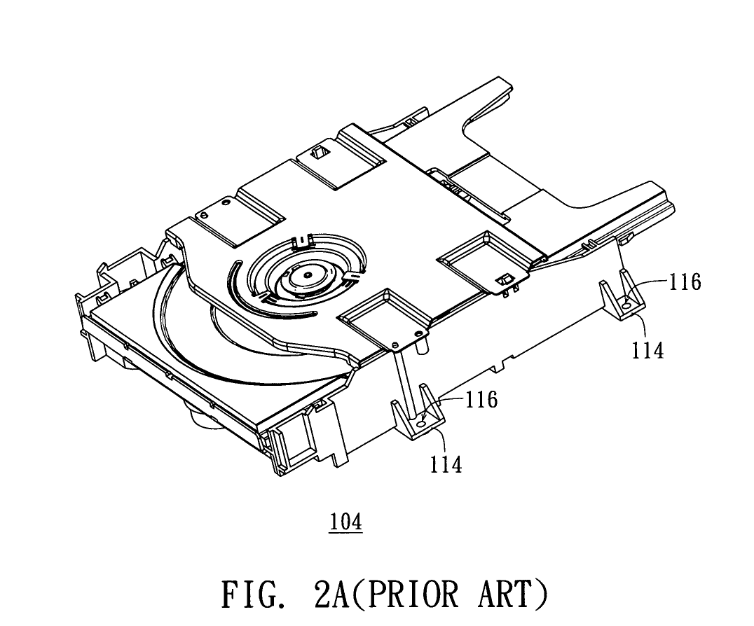

FIG. 2B (Prior Art) is a top view showing the main body in FIG. 2A.

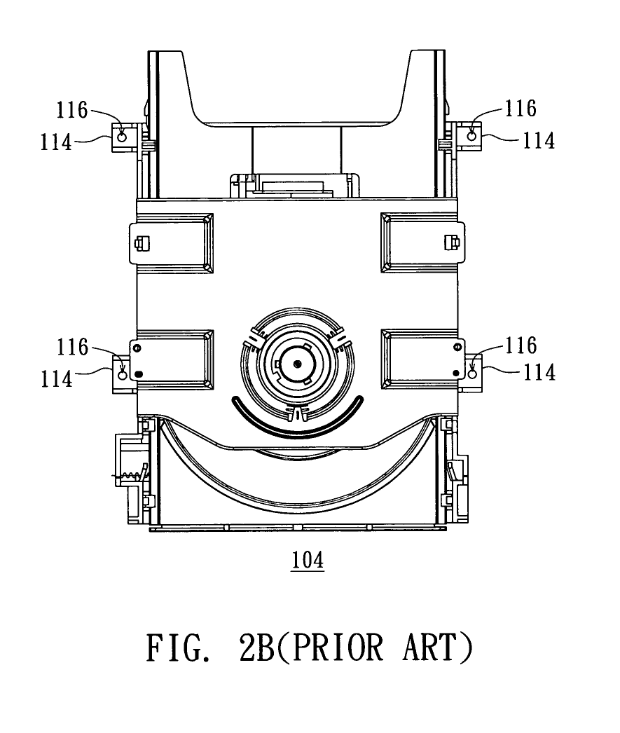

FIG. 3 (Prior Art) is a top view showing another main body of a conventional multi-functional disc player.

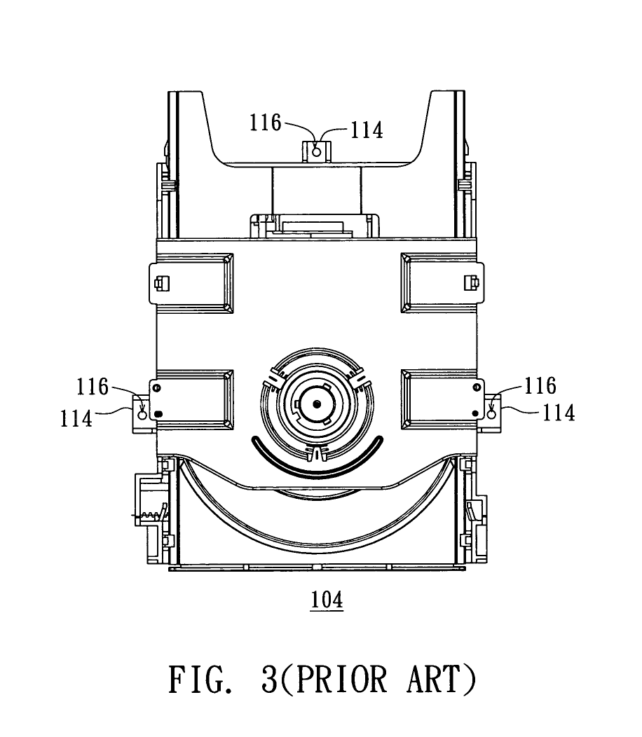

FIG. 4 (Prior Art) is a top view of the conventional multi-functional disc player in FIG. 1.

FIG. 5 is a diagram showing a main body of a multi-functional disc player according to the preferred embodiment of the present invention.

FIG. 6 is a cross-section view of the multi-functional disc player according to the preferred embodiment of the present invention.

FIG. 7 is a top view showing the multi-functional disc player in FIG. 6.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

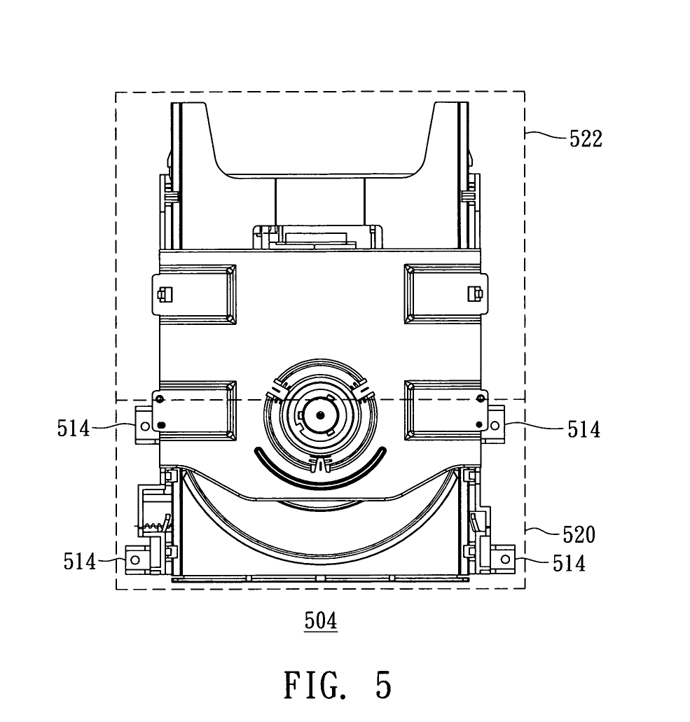

Referring to FIG. 5, it is a diagram showing the main body of a multi-functional disc player according to the preferred embodiment of the present invention. The main body 504 of the multi-functional disc player 500 has a first side 520 and a second side 522, and the second side 522 is opposite to the first side 520.

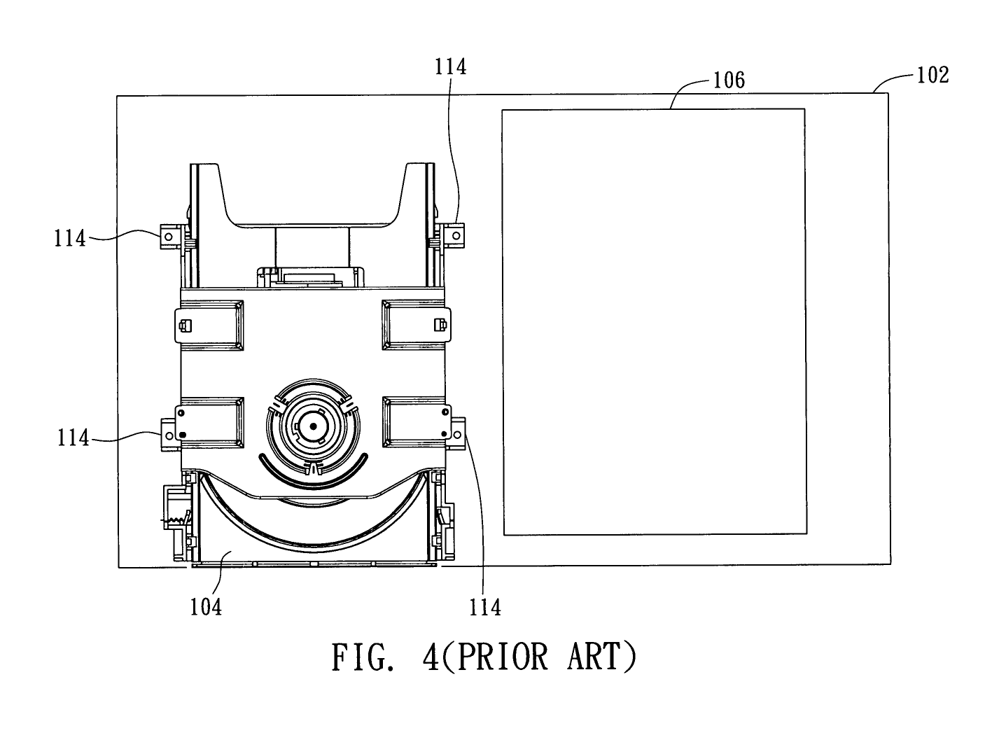

As compared with the main body 104 of the conventional multi-functional disc player in FIG. 4, there is a supporting member 514 disposed at the first side 520 of the main body 504 of the multi-functional disc player 500. The supporting member 514 is for support the main body 504 and allows the main body 504 being coupled to the base of the multi-functional disc player 500 via the supporting member 514.

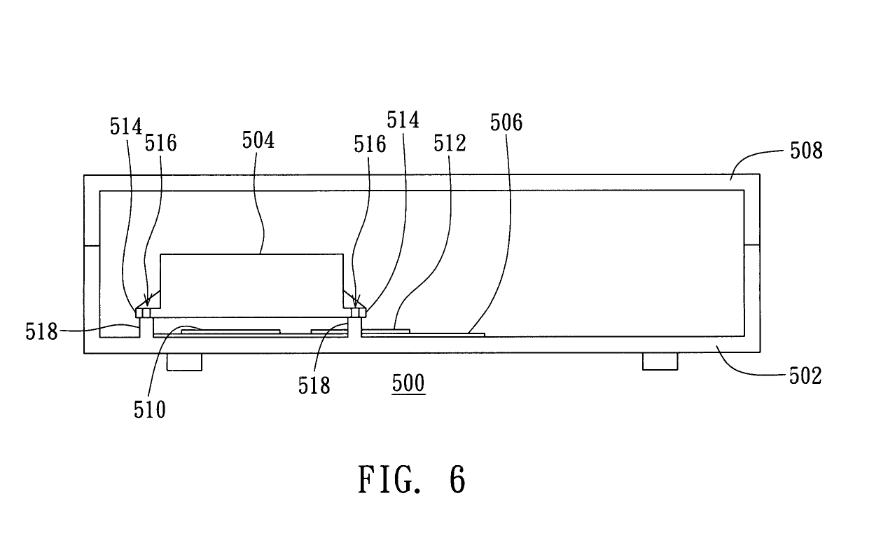

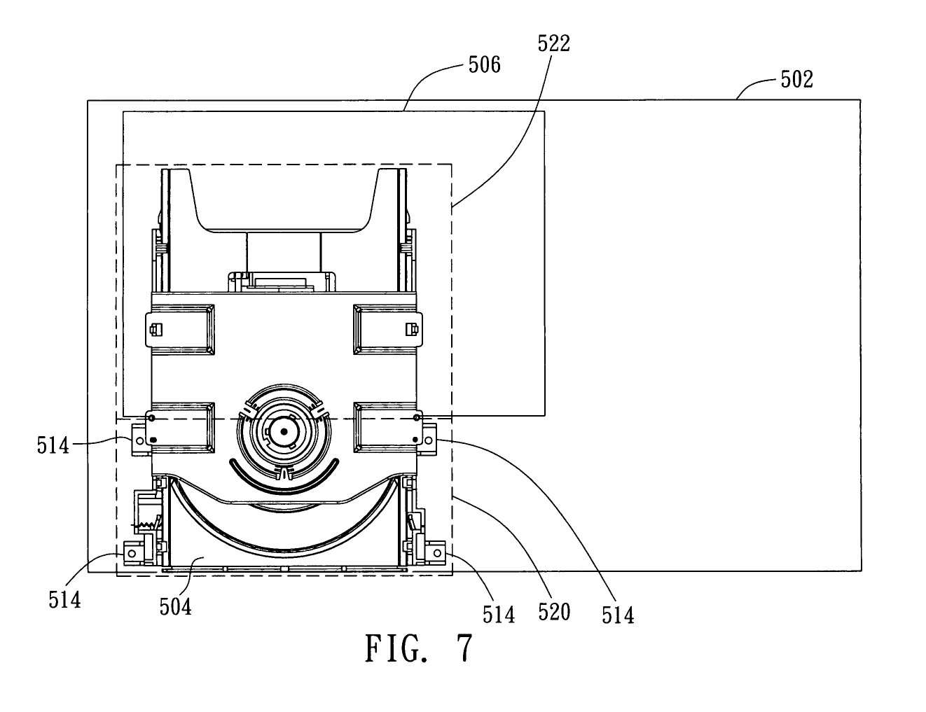

Referring both to FIG. 6 and FIG. 7, FIG. 6 is a cross-section view of the multi-functional disc player according to the preferred embodiment of the present invention, and FIG. 7 is a top view showing the multi-functional disc player in FIG. 6. The multi-functional disc player 500 of the present invention further includes the base 502, the cover 508 for covering the base 502 and being connected thereto, and electronic means, such as the circuit board 506. In FIG. 6, a protruding member 518 is disposed on the surface of the base 502, and the protruding member 518 is located with respect to the supporting member 514 of the main body 504. Moreover, there are a main body control chip 510 and a MPEG decompressing chip 512 on the circuit board 506.

It is noticed that in FIG. 7, when the cover 508 of FIG. 6 is removed, the base 502, the main body 504, and the circuit board 506 can be seen directly without shelter of the cover 508.

The main body 504 is coupled to the protruding member 518 of the base 502 via the supporting member 514 located on the first side of the main body 504. Conventionally, the main body 504 is locked onto the base 502 via a screw through the screw hole 516 of the supporting member 514 so as to have the main body 504 dispose on the base 502.

The protruding member 518 prevents the screw from protruding outside of the base 502, and the main body 504 is disposed on the protruding member 518 of the base 502 via the supporting member 514 so as to form a receiving space between the second side 522 of the main body 504 and the base 502.

Therefore, parts or all parts of the circuit board 506 and other components disposed on the base 502 of the multi-functional disc player 500 can be disposed in the receiving space between the second side 522 of the main body 504 and the base 502.

In the abovementioned embodiment, the disc driving motor, the spindle motor and the optical pickup head of the main body 504 are usually disposed on the first side 520 of the main body 504, so that the thickness of the first side 520 is greater than that of the second side 522 of the main body 504. Hence, if the supporting member 514 is disposed on the second side 522 to form a receiving space between the first side 520 and the base 502, it may cause a disadvantage that the circuit board 596 and other components may interface with the main body 504. As a result, it is suggested to have the supporting member 514 be disposed on the second side 522.

Further, considering that the first side 520 of the main body 504 faces to the front panel of the multi-functional disc player 500, and the second side 522 of the main body 594 faces to the back panel of the multi-functional disc player 500, the present invention provides a convenience that the terminals on the back panel of the multi-functional disc player 500 is easy to be connected to the circuit board 506.

However, the prevent invention is not limited to that the supporting member 514 only being disposed on the first side 520 of the main body 504. Any configuration on the main body 504 can be applied as long as a receiving space is formed.

As described hereinbefore, by employing the supporting member 514 on the first side 520 of the main body 504 according to the preferred embodiment of the present invention, a larger space is provided between the second side 522 and the base 502 so as to allow parts or all parts of the circuit board 506 be disposed in the receiving space. The present invention can increase the space within the base 502, and makes the configuration more flexible.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A disc depositing apparatus comprising:
a main body, having a first side and a second side, wherein the second side is opposite to the first side;
a supporting member, disposed at the first side; and
a base, having a protruding member disposed thereon, wherein the main body is coupled to the protruding member of the base via the supporting member so as to form a receiving space between the second side of the main body and the base.

2. The disc depositing apparatus according to claim 1 further comprising electronic means, part of which is disposed in the receiving space.

3. The disc depositing apparatus according to claim 2, wherein the electronic means includes a circuit board.

4. The disc depositing apparatus according to claim 3, wherein the circuit board has a main body control chip disposed thereon.

5. The disc depositing apparatus according to claim 3, wherein the circuit board has a MPEG decompressing chip disposed thereon.

6. The disc depositing apparatus according to claim 1 further comprising a cover for covering the base and being connected thereto.

7. The disc depositing apparatus according to claim 1, wherein the disc depositing apparatus is a digital versatile disc player (DVD player) or a video compact disc player (VCD player).

8. A digital versatile disc player (DVD player), comprising:
a main body, having a first side and a second side, wherein the second side is opposite to the first side;
a supporting member disposed at the first side;
a base, having a protruding member disposed thereon, wherein the main body is coupled to the protruding member of the base via the supporting member so as to form a receiving space between the second side of the main body and the base;
electronic means, part of which is disposed in the receiving space; and
a cover for covering the base and being connected thereto.

9. The DVD player according to claim 8, wherein the electronic means includes a circuit board.

10. The DVD player according to claim 9, wherein the circuit board has a main body control chip disposed thereon.

11. The DVD player according to claim 9, wherein the circuit board has a MPEG decompressing chip disposed thereon.
